(19) United States
(12) Patent Application Publication
(10) Pub. No.: US 2015/0256568 A1
(43) Pub. Date: Sep. 10, 2015

(54) PHOTO-REVIEW CREATION

(71) Applicant: Triptease Limited, London (GB)

(72) Inventors: Charlie Osmond, London (GB); Alasdair Snow, London (GB)

(73) Assignee: Triptease Limited, London (GB)

(21) Appl. No.: 14/287,386

(22) Filed: May 27, 2014

Related U.S. Application Data
(60) Provisional application No. 61/947,953, filed on Mar. 4, 2014.

(51) Int. Cl. H04L 29/06; H04L 29/08; G06F 3/0484

(52) U.S. Cl. CPC H04L 65/403; G06F 3/04842; H04L 67/02

(57) ABSTRACT

Photo-reviews provide an aesthetically pleasing and rich review experience resulting in greater comprehension and understanding of a reviewable item. In addition to providing a richer review format that is aesthetically pleasing, photo-reviews can also increase the number of inquiring users that find and ultimately view the photo-review. For example, many search engines utilize a search algorithm that prioritizes results including images over results that do not include an image. As a result, photo-reviews can receive a higher search ranking leading to more overall views by inquiring users. To promote including a photo in a review, pre-associated images relating to a reviewable item can also be provided to the user. Pre-associated images can be images known to be of or relating to a reviewable item. A reviewing user can select to include one or more of the pre-associated images in their photo-review, thereby simplifying creation of the photo-review for the user.

### CROSS REFERENCE TO RELATED APPLICATIONS

This application claims the benefit of U.S. provisional application 61/947,953 filed on Mar. 4, 2014 and the contents thereof are expressly incorporated by reference herein it its entirety.

### TECHNICAL FIELD

The present technology pertains to photo-reviews, and more specifically pertains to creating and posting a photo review.

### BACKGROUND

The field of providing reviews changed dramatically with the advent of the Internet. Reviewing users can now quickly create and publicly post reviews regarding just about any product, service, business, location, etc. For example, a reviewing user can generate and post a review to one of a number of review websites freely available on the Internet. While these review websites provide a fantastic forum for reviewing users to share their particular experiences and/or opinion; ensuring that the submitted reviews are discoverable to inquiring users trying to gain insight regarding a specified product, service, location, etc., provides other challenges.

For example, the increased number of posted reviews can increase the difficulty in finding any one review. Further, the current review format provided by review websites often limit the information that a user can provide to an overall rating and short explanation. While this limited format does provide some description, it results in an aesthetically unpleasing review that is limited to the descriptive abilities of the reviewing user for description. Accordingly, there is a need for an improved review format.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for creating and posting photo-reviews. Photo-reviews, including at least one photograph of a reviewable item, provide an aesthetically pleasing and rich review experience. An inquiring user can view images along with the comments provided by a reviewer, resulting in greater comprehension and understanding of the reviewable item. In addition to providing a richer review format that is aesthetically pleasing, photo-reviews can also increase the number of inquiring users that find and ultimately view the photo-review. For example, many search engines utilize a search algorithm that prioritizes results including images over results that do not include an image. As a result, photo-reviews can receive a higher search ranking leading to more views by inquiring users.

A review management system can identify users eligible to create a review for one or more reviewable items, such as hotels, restaurants, services, locations, purchasable items, etc., and prompt the identified users to create a photo-review. For example, identified users can be presented with a photo-review creation interface enabling a user to create a photo-review.

While a user can provide personal photographs to include in a photo-review, in some embodiments, pre-associated images relating to a reviewable item can also be provided to the user. Pre-associated images can be images known to be of or relating to a reviewable item that have been associated with the reviewable item. A reviewing user can select to include one or more of the pre-associated images in their photo-review, thereby simplifying creation of the photo-review for the user.

In some embodiments, the created photo-review can be posted to a review website that maintains reviews for a number of different reviewable items. Further, in some embodiments, the review management system can determine if the reviewing user has one or more social networking accounts and, if so, prompt the reviewing user to post the photo review to one of their social networking accounts. For example, the reviewing user's e-mail address can be used to determine if the reviewing user has a social networking account with one or more social networking websites. Posting photo-reviews to a social networking site can further increase the number of views that a photo-review receives.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example electronic environment in which methods and systems discussed herein can be executed, in accordance with various embodiments;

FIG. 2 illustrates an exemplary embodiment of a photo-review interface that allows a user to create a photo-review;

FIGS. 3A-3B illustrate an exemplary embodiment of a photo-review interface for creating photo-reviews;

FIG. 4 illustrates an exemplary embodiment of a photo-review interface for editing a photo-review;

FIG. 5 illustrates an exemplary embodiment of a photo-review;

FIG. 6 illustrates an exemplary method embodiment of creating a photo review; and

FIGS. 7A-7B illustrate exemplary electronic environments, in accordance with various embodiments.

### DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure.

The disclosed technology addresses the need in the art for creating and posting photo-reviews. Photo-reviews, including at least one photograph of a reviewable item, provide an aesthetically pleasing and rich review experience. An inquiring user can view images along with the comments provided by a reviewer, resulting in greater comprehension and understanding of the reviewable item. In addition to providing a richer review format, photo-reviews can also increase the number of inquiring users that find and ultimately view the photo-review. For example, many search engines utilize a search algorithm that prioritizes results including images over results that do not include an image. As a result, photo-reviews can receive a higher search ranking leading to more overall views by inquiring users. In addition, photo-reviews may be posted on social networking platforms, as will be addressed below in greater detail.

A review management system can identify users eligible to create a review for one or more reviewable items, such as hotels, restaurants, services, locations, items, etc. and prompt the identified users to create a photo-review. For example, identified users can be presented with a photo-review creation interface enabling a user to create a photo-review.

While a user can provide personal photographs to include in a photo-review, in some embodiments, pre-associated images relating to a reviewable item can also be provided to the user. Pre-associated images can be images known to be of or relating to a reviewable item. A reviewing user can select to include one or more of the pre-associated images in their photo-review, thereby simplifying creation of the photo-review for the user.

In some embodiments, the created photo-review can be posted to a review website that maintains reviews for a number of different reviewable items. Further, in some embodiments, the review management system can determine if the reviewing user has one or more social networking accounts and, if so, prompt the reviewing user to post the photo review to one of their social networking accounts. For example, the reviewing user's e-mail address can be used to determine if the reviewing user has a social networking account with one or more social networking websites.

As used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

As used herein, the term “user” shall be considered to mean a user of an electronic device(s). Actions performed by a user in the context of computer software shall be considered to be actions taken by a user to provide an input to the electronic device(s) to cause the electronic device to perform the steps embodied in computer software.

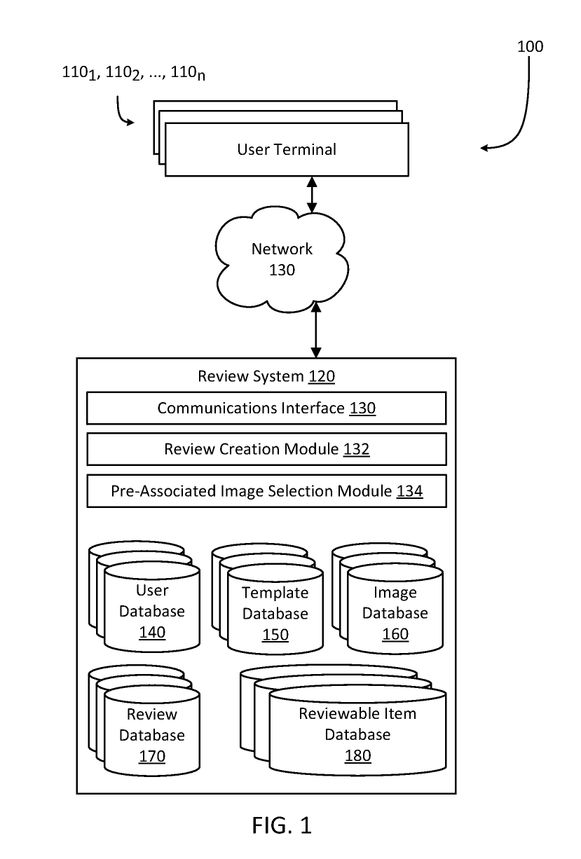

An exemplary system configuration 100 is illustrated in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, content can be delivered to client devices 110₁, 110₂, . . . , 110ₙ (collectively “110”) connected to network 130 by direct and/or indirect communications with review management system 120. Client devices 110 can be any network enabled computing device, such as desktop computers; mobile computers; wearable computers; handheld communications devices, e.g. mobile phones, smart phones, tablets; smart televisions; set-top boxes; and/or any other network enabled computing devices. Furthermore, review management system 120 can concurrently accept connections from and interact with multiple client devices 110.

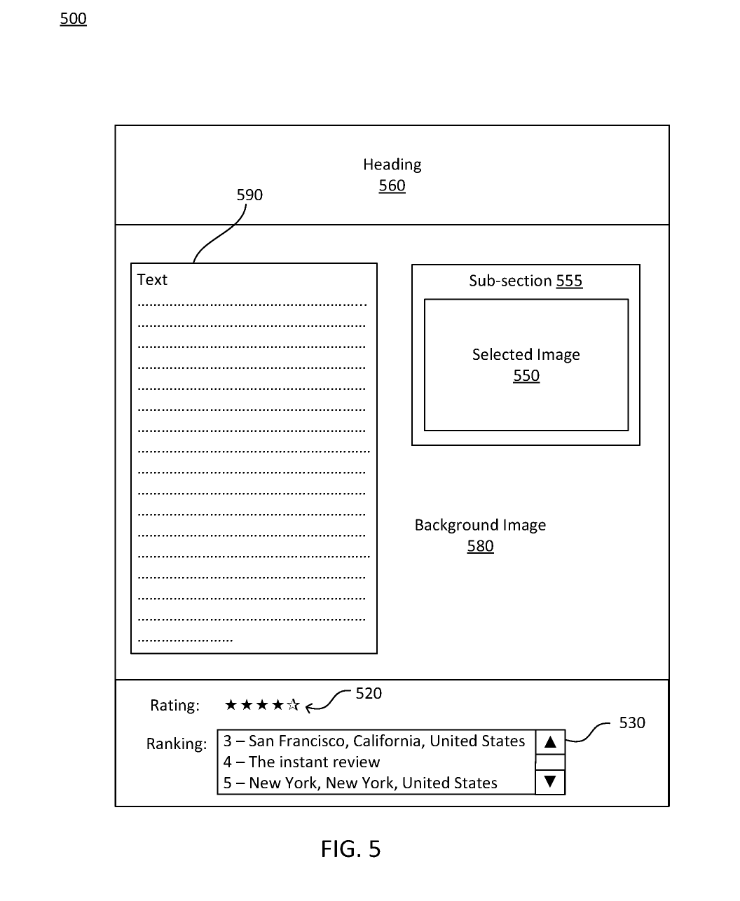

Review management system 120 can be one or more servers and can receive a request for electronic content, such as a web page, an application, a media item, etc., from one of client devices 110. Thereafter, review management system 120 can assemble a content package and transmit the assembled content page to the requesting one of client devices 110. An assembled content package can include text, graphics, audio, video, executable code, or any combination thereof. Further an assembled content package can include a photo-review, such as photo-review 500 (of FIG. 5) created by users via review management system 120. To facilitate communications with the client devices 110 and/or any other device or component, review management system 120 can include communications interface 130.

Review management system 120 can comprise or be coupled with one or more databases (or other data storage devices) including user profile database 140 that contains user profiles or other information about users, template database 150 that contains templates to assist with the creation of photo-reviews, pre-associated image database 160 which can include pre-associated images of reviewable items, photo-review database 170 which can contain photo-reviews created by users or administrators, and reviewable item database 180 which can contain items that can be reviewed.

Reviewable items can include any item, service, business, etc., that can be reviewed. For example, reviewable items can include, but are not limited to: geographic locations such as countries or regions, lodging such as a hotel or hostel, transportation such as an airline or cruise ship, restaurants, landmarks, restaurants, entertainment, businesses, purchasable items, etc.

Review management system 120 can include photo-review creation module 132 that can be configured to interact with various databases to create photo-reviews. For example, photo-review creation module 132 can interact with some or all of the databases shown in FIG. 1 (i.e., user profile database 140, template database 150, pre-associated image database 160, photo-review database 170, and reviewable item database 180).

To create photo-reviews, photo-review creation module 132 can be configured to identify potential reviewing users and prompt the identified potential reviewing users to create a photo-review. For example, in some embodiments, user profiles stored in user profile database 140 can include data regarding activities of the users in relation to reviewable items in reviewable item database 180. Activities can include any sort of action performed by a user, such as purchases made, vacations taken by the user, reservations made by the user, etc. Photo-review creation module 132 can communicate with user profile database 140 to access the user profiles and identify users that have recorded activity with a reviewable item in reviewable item database 180. For example, photo-review creation module 132 can identify user profiles including data that a user stayed at a hotel included in reviewable item database 180.

Further, in some embodiments, photo-review creation module 132 can identify potential reviewing users from data stored on 3^{rd} party databases that include activity data regarding users. For example, 3^{rd} party databases belonging to travel websites, reservation websites, online marketplaces, etc., can include activity data regarding users, such a as purchases, vacations, reservations, etc. associated with the user. Photo-review creation module 132 can be configured to communicate with one or more 3^{rd} party databases to identify users that have recorded activity with a reviewable item in reviewable item database 180.

Alternatively, in some embodiments, review management system 120 can receive a notification identifying a potential reviewing user. For example a 3^{rd} party, such as a travel website can transmit data to review management system 120 that identifies potential reviewing users. For example, upon a user purchasing an item or completing a vacation purchased through the 3^{rd} party's website, the 3^{rd} party server can transmit the notification message to review management system 120. The notification message can include information identifying the user as well as the reviewable item the user is eligible to review. Further, in some embodiments the notification can include contact information for the user, such as an e-mail address. Photo-review creation module 132 can use the data received in the notification to prompt the user to create a photo-review.

Photo-review creation module 132 can be configured to prompt potential reviewing users to create a photo-review regarding one or more reviewable items. For example, upon identifying that a user has recorded activity with a reviewable item, such as a data indicating that user stayed at a specified hotel, photo-review creation module 132 can prompt the user to create a photo-review for the specified hotel. In some embodiments, a user may be prompted by various means including: email, text-message, Bluetooth Low Energy (LE), push notifications, etc. In some embodiments, incentives may be provided to a user to encourage the user to create photo-reviews. For example, a place of business may provide a user with a discount in response to the user creating and/or publishing a photo-review. In some instances, a hotel may provide coupons to its bar for patrons that created photo-reviews. In some embodiments, rewards are provided to users in response to sharing photo-reviews with friends (e.g., emailing, texting, or posting to photo-reviews to a social network). In various embodiments, a business may choose the types of incentives to provide a user with (e.g., via photo-review creation module 132). In some embodiments, merely entering an email address will cause a user to receive a coupon or other type of reward.

In some embodiments, photo-review creation module 132 can send the potential reviewing user a photo-review request prompting the user to create a review for the reviewable item. For example, photo-review creation module 132 can gather contact information for the user, such as the user's e-mail address, phone, social networking account, etc., from the user's profile in user profile database 140 and use the gathered contact information to transmit the photo-review request to the potential reviewing user.

Alternatively, in some embodiments, a 3^{rd} party server can transmit the photo-review request to a potential reviewing user. For example, rather than send a notification to review management system 120 identifying a potential reviewing user, the 3^{rd} party server can send a photo-review request directly to the identified user.

In some embodiments, the photo-review request can prompt a potential reviewing user to create a photo-review for a specified reviewable item. Alternatively, the photo-review request can prompt a potential reviewing user to create a photo-review for multiple reviewable items. For example, the photo-review request can prompt a user to create a photo-review for each reviewable item for which user activity was detected.

In some embodiments, the photo-review request can identify the one or more reviewable items that the user can review, and enable a user to select to initiate the photo-review process with any of the reviewable items. For example, the photo-review request can include interactive elements, such as buttons, links, etc., that, when selected, initiate the photo-review creation process for the specified reviewable item.

In some embodiments, photo-review creation module 132 can be configured to present the reviewing user with a photo-review creation interface that provides the users with the tools, data, etc., to create a photo-review. This can include providing templates, pre-associated images, etc., that can be used to create a photo-review.

Photo-review creation module 132 can be configured to select one or more available templates to provide the reviewing user. In some embodiments, photo-review creation module 132 can select templates based on the reviewable item. For example, the templates can be selected based on the type of reviewable item, such as a whether the reviewable item is a purchasable item, restaurant, location, hotel, airline, etc. Templates stored in template database 150 can include metadata identifying a type of reviewable item the template is best suited for and photo-review creation module 132 can use the metadata to select the templates best suited for the type of the reviewable item to be reviewed.

Alternatively, in some embodiments, photo-review creation module 132 can select templates based on other metadata describing the reviewable item. For example, templates associated with a beach or vacation theme can be selected when the reviewable item is a beach resort. Alternatively, templates associated with an urban or modern theme can be selected when the reviewable item is a hotel located in a major city such as New York.

As another example, the templates can be selected based on physical attributes of the reviewable item. For example, templates can be selected based on the shape of the reviewable item. For example, if the reviewable item is the Eiffel Tower, photo-review creation module 132 can select templates with a greater height than width to mimic the proportions of the Eiffel Tower. Alternatively, the template selected can be based on a distinguishing feature of the reviewable item. For example, if the reviewable item is Paris, a template can be selected based on a distinguishing feature of Paris, such as the Eiffel Tower.

A template can include one or more configurable areas enabling a user to create a photo-review. For example, a template can include configurable areas designed to present photographs, text, headings, audio, video, etc. A user can use the photo-review interface to select one of the provided templates and interact with the configurable areas of the template to create the photo-review. For example, the photo-review interface can enable a user to enter text, images, etc. into the configurable areas.

A user can select a personal photograph to include in a photo-review. For example, the photo-review interface can enable a user to upload a photograph from client device 110. Alternatively, in some embodiments, photo-review creation module 132 can provide one or more pre-associated images for the user to include in the photo-review. Pre-associated image database 160 can include images that are each pre-associated with one or more reviewable items in reviewable item database 180 and photo-review creation module 132 can present the pre-associated images to the user for use in the photo-review. For, example, the pre-associated images can be presented such that a user can select one of more of the pre-associated images to include in the photo-review.

In some embodiments, the pre-associated images can be images received from a business associated with the reviewable item, such as a hotel, restaurant, etc. Further, in some embodiments, photographs uploaded by users creating a photo-review of a reviewable item can be stored and pre-associated with the reviewable item for use by other users. Finally, in some embodiments, pre-associated images can be selected from image searches performed based on the reviewable item and stored for later use.

To pre-associate an image with a reviewable location, metadata identifying the reviewable items associated with the image can be stored along with the image. Photo-review creation module 132 can search the metadata to identify images pre-associated to a specified reviewable item.

In some embodiments, photo-review creation module 132 can present all of the pre-associated images to a reviewing user. Alternatively, in some embodiments, photo-review creation module 132 can present a subset of the available pre-associated images. For example, photo-review creation module 132 can select a subset of the pre-associated images based on the template selected by a reviewing user. For example, pre-associated images can be pre-associated with one or more templates in addition to a reviewable item. For example, images can be pre-associated with a template because they fit a theme or color palette used by a template. Each pre-associated image can include metadata identifying the templates that the image is pre-associated with and photo-review module 132 can search the metadata to identify the appropriate pre-associated images.

In some embodiments, photo-review creation module 132 can select a subset of the pre-associated images based on the size or shape of the selected template and/or configurable areas of the selected template. For example, pre-associated images that fit the size or proportion of the configurable areas of the selected template can be selected to present to the user for use in the photo-review.

Photo-review creation module 132 can gather metadata from the template and the pre-associated images to determine the size, proportions, etc., of the pre-associated images, template and configurable areas, and then select a subset of the pre-associated images accordingly. For example, in some embodiments, photo-review creation module 132 can select a subset of the pre-associated images that have a total area within a predetermined variance of the area of a template and/or configurable area. Alternatively, in some embodiments, photo-review creation module 132 can select a subset of the pre-associated images that have proportions, i.e. height and length, within a predetermined variance of the template and/or configurable area.

In some embodiments, photo-review creation module 132 can select a subset of the pre-associated images based on a review focus associated with a configurable area of the template. For example, a template can include multiple configurable areas that each have a designated review focus. For instance, a template for a photo-review of a hotel can include a configurable area designated to the rooms and another configurable are designated to the pool. Photo-review creation module 132 can select a subset of the pre-associated images to present to a user based on the configurable areas included or selected by a user and the review focus associated with the configurable areas. Thus, when a user selects a configurable area designated to the pool, photo-review creation module 132 can select a subset of the pre-associated images of the hotel that are images of the pool. Likewise, when a user selects a configurable area designated to the room, photo-review creation module 132 can select a subset of the pre-associated images of the hotel that are images of the rooms.

In some embodiments, photo-review creation module 132 can select a subset of the pre-associated images based on input received from the user. For instance, a template can be configured to enable a user to select or enter a heading for the template and/or the configurable area and photo-review creation module 132 can select a subset of the pre-associated images based on the selected or entered heading. Thus, if a user selects or enters a heading regarding pools, photo-creation module 132 can select a subset of the images that are related to pools.

Alternatively, in some embodiments, photo-creation module 132 can select a subset of the pre-associated images based on an analysis of the text entered by a user. For example, text entered by a user may include keywords that suggest a topic that the user is discussing. Photo-review creation module 132 can scan the entered text to identify keywords and then select a subset of the pre-associated images that are related to the identified keywords. For example, if the text includes the keyword ‘pool’, photo-creation module can select a subset of the pre-associated images that are related to the pool.

In some embodiments, photo-review creation module 132 can be configured to automatically crop images selected by a user to include in a photo-review. Thus an image selected by a user can automatically be included by a user without further input from the user. For example, in some embodiments, photo-review creation module 132 can crop the image to fit the proportions of the template or configurable area of the template. The cropped image can then be reduced or expanded to fit the configurable area.

Alternatively, in some embodiments, photo-review module 132 can crop images based on a determined focal point of the image. For example, a pre-associated image can include of focal point which can be used as a center to crop the image. In some embodiments, images can be cropped, rotated, and/or resized such that the focal point remains centered. In some embodiments, the image can include metadata that identifies the focal point. Alternatively, in some embodiments, an image can be analyzed to determine the focal point. For example, a person's pupils in the image can be determined to be the focal point of the image. As another example, the largest captured object in the image can be determined to be the focal point of the image. In some embodiments, a user can select the focal point of the image.

In some embodiments portions of content that comprise a photo-review such as a background image, foreground images, photo-review regions, text boxes, etc. may be merged (or flattened) into a single layer of content. For example, when a user is finished creating a photo-review, they may select an action that compresses the content within the photo-review by blending, merging, or otherwise combining portions of content within the photo-review. In some embodiments a user may rasterize an image of a photo-review. A user may create a .jpg, .pdf or .gif image of text and/or other content overlaying a background image in a photo-review as opposed to a review where images are simply adjacent to the text and/or associated rating of the review.

In some embodiments, the user can create a single file or package for easy sharing. While the review includes independent text, photos, etc, a single file can be created for export and sharing on different platforms.

Photo-reviews created by a user can be posted and made publicly available by review system 120. For example, photo-reviews can be posted to a review website hosted by review system 120, where they can be searched and accessed by inquiring users. Similarly, photo-review system 120 may be configured to post the review to various social media sources, or to include links to social media platforms on the review. In some embodiments, a photo-review may be modified based on the social media platform that the photo-review is sent to. For instance, some social media platforms may require (or be better suited for receiving) square images while other social media platforms have no requirement or preference. In such a case, if a user uploads the photo-review to a platform that requires or is better suited for square images, then the photo-review may be automatically cropped or otherwise modified based upon the platform. In various embodiments the photo-review system 120 is operable to provide a user with a choice of formats of which to send their review. For instance, although a user may have created a rectangular shaped photo-review using a rectangular shaped template, the photo-review system 120 may allow the user to crop the photo-review or otherwise modify it before sending the photo-review to a particular platform. In some embodiments, a photo-review may be sent as a text and/or multi-media message. In addition, in some embodiments, a photo-review may be provided to a user when the user (or their electronic device) attempts to connect to an internet service provider, such as a wireless network at a on an airplane or at a hotel.

In some embodiments, photo-review creation module 132 can enable a user to post a photo-review to a social networking site. For example, photo-creation module 132 can generate a link that can be used to access the created photo-review. A user can then post the link to their social networking account. Alternatively, in some embodiments, photo-creation module 132 can access a user's social networking account and post the generated link to the user's feed on the social networking site. For example, a user can be prompted to provide their login credentials which can then be used to access the user's account on the social networking site.

In some embodiments, photo-creation module 132 can be configured to determine whether a user has a social networking account and, if so, prompt the user to post their photo-review to their social networking account. For instance, in some embodiments, user profile data associated with the user in user database 140 can indicate that a user has a social networking account. For example, a user may have posted a photo-review to a social networking account in the past and a record can be kept in the user's profile. Photo-review creation module 132 can access the user's profile in user database 140 to determine whether the user has a social networking account.

Alternatively, in some embodiments, photo-review creation module 132 can query social networking sites to determine whether the user has a social networking account. For example, photo-review creation module 132 can use a user's known e-mail address to query social networking sites to determine whether an account associated with the e-mail address exists.

While review management system 120 is presented with specific components, it should be understood by one skilled in the art, that the architectural configuration of review management system 120 is simply one possible configuration and that other configurations with more or less components are also possible.

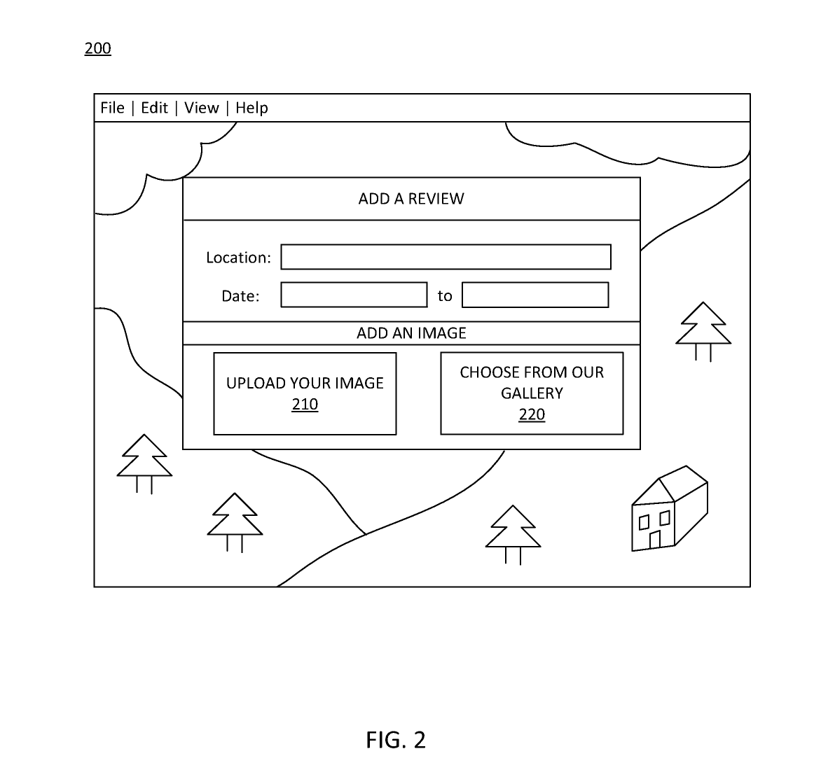

FIG. 2 illustrates an exemplary embodiment of photo-review interface 200 configured to allow a user to create a photo-review. As shown, photo-review interface 200 includes input field 205 configured to receive a reviewable item to review. Although input field 205 prompts a user to enter a location to review, this is just one possible embodiment and is not meant to be limiting. Input field 205 can prompt a user to enter any type of reviewable item, such as a restaurant, purchasable item, hotel, etc.

A user can input a reviewable item that the user would like to review in input field 205. For example, the user can type in the name of a reviewable item to select to review the reviewable item. Alternatively, in some embodiments, photo-review interface 200 can be configured to present the user with a selection or know reviewable items and the user can select one. For example, input field 205 can be configured to present a drop down menu that lists known reviewable items.

As shown, photo-review interface 200 also includes input fields 215 configured to receive a starting and ending date associated with the reviewable item. For example, when reviewing a reviewable item such as a hotel or location, a user can enter the dates the user stayed at the hotel or location into input fields 215.

Photo-review interface 200 can also be configured to enable a user to include one or more images to the photo-review. For example, photo-review interface 200 can include user interface element 210 configured to enable a user to upload an image. A user can select user interface element 210, resulting in a selection interface being presented that enables a user to select a personal image stored on the user's client device.

Alternatively, a user can select to include a pre-associated image by selecting user interface element 220. Upon selection, user interface element 220 can be configured to present the user with one or more pre-associated images associated with the reviewable item entered in input field 205. In some embodiments, user interface element 220 can remain inactive, meaning that it cannot be selected, until a user enters a reviewable item into input field 205 for which there are available pre-associated images.

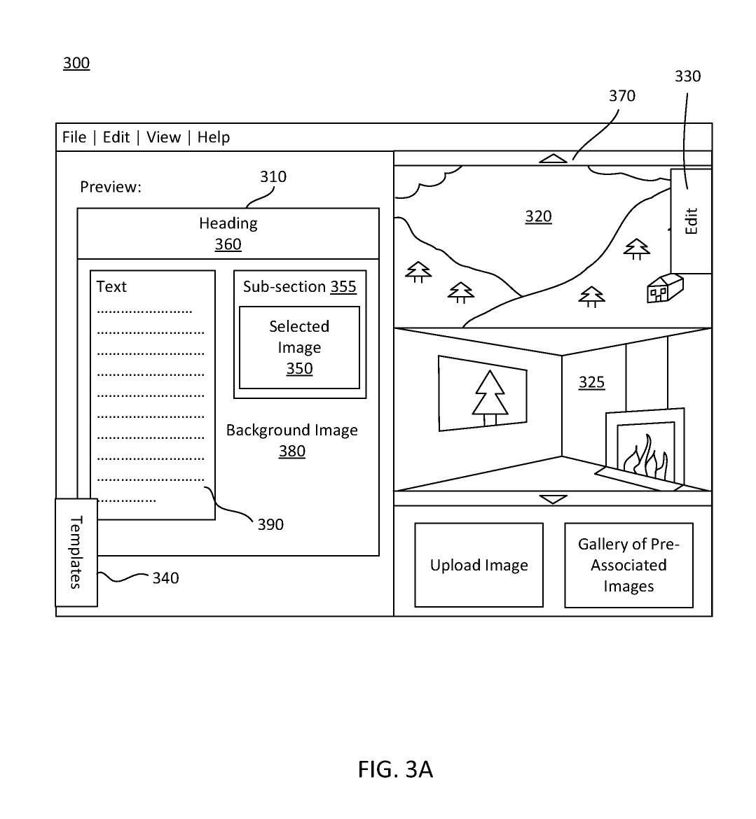

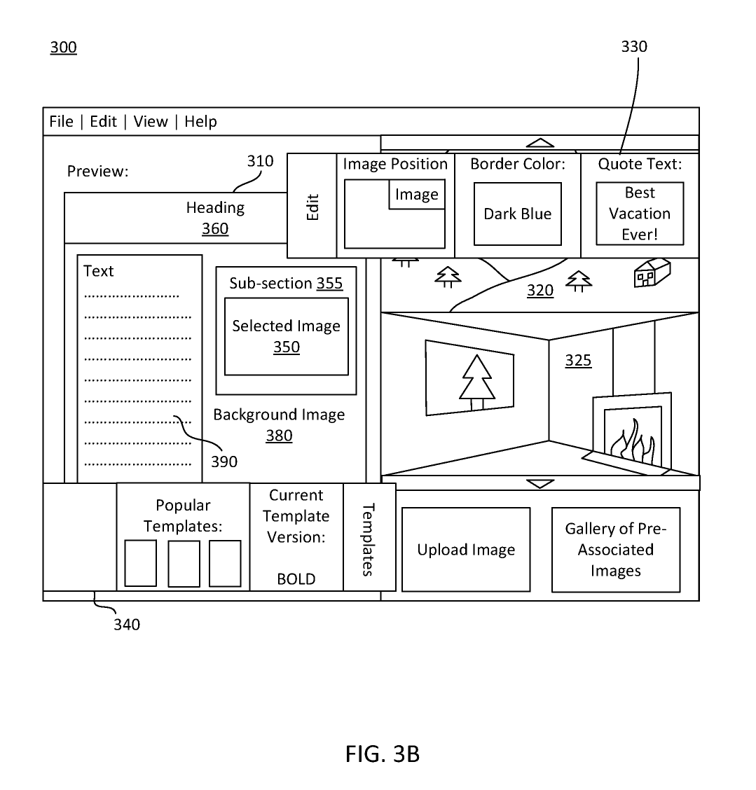

FIGS. 3A and 3B illustrate exemplary embodiments of a photo-review interface. As shown in FIG. 3A, photo-review interface 300 can present template 310, which can be customized to create a photo-review. Template 310 can include multiple configurable areas that the user can edit to include text, photos, etc. to create a photo-review. For example, template 310 can include configurable area 360 configured to receive a heading for the photo-review. A user can enter text to provide a heading, or, alternatively, select from provided headings.

Template 310 can also include configurable area 390 configured to receive text describing the reviewable item. A user can select configurable area 390 and enter a description of the reviewable item. Template 310 can also include configurable area 380 configured to receive an image. A user can upload an image from their client device, for example by selecting user interface element 305 or, alternatively, select a pre-associated image from a library of pre-associated images by selecting user interface element 315.

As shown, two pre-associated images 320, 325 are presented for a user to select to include in the photo-review. In some embodiments, the pre-associated images presented can be based generally on the reviewable item. Alternatively, in some embodiments, the pre-associated images presented can be further filtered based on input received from the user. For example, the pre-associated images can be filtered based on the heading entered by the user in configurable area 360. Alternatively, the pre-associated images can be filtered based on an analysis of the text entered into configurable area 390. A user can navigate through the available pre-associated images using inputs 370 and select one of the pre-associated images to include in the photo-review.

Template 310 can also include configurable area 355 that can represent a sub-section of the photo-review. For example, a user can use configurable area 355 to provide images, text, etc., regarding a specific portion of the reviewable item. For instance, if the user is creating a photo-review for a hotel, the user can utilize configurable area 355 to provide specific detail about a single aspect of the hotel, such as the pool, restaurants, etc.

As shown, configurable area 355 includes configurable area 350 configured to receive an image. A user can select to upload a personal image or select a pre-associated image from the library of pre-associated images. If a user chooses to select a pre-associated image, the pre-associated images presented to the use for selection can be filtered based on input presented in configurable area 355. For example, if the user selects a heading or enters text into configurable area 355 indicating the topic of the sub-section, the pre-associated images presented to the user for selection can be filtered based on the topic. For example, if the user selects a heading such as pools in configurable area 355, the pre-associated images presented to the user to include in configurable area 350 can be filtered to include images of the pool.

Photo-review interface 300 can also include user interface element 340 that enables a user to select a different template to create a photo-review. Further, photo-review interface element 330 can also include user interface element 330 configured to enable a user to edit a selected template.

FIG. 3B illustrates an exemplary embodiment of photo-review interface 300 after a user has selected user interface elements 340 and 330. As shown, selection of user interface element 340 results in an expanded control set being presented to the user. As shown, a user can select from multiple provided templates as well as edit the current version of the template.

Similarly, selection of user interface element 330 reveals an expanded control set. As shown, the control set enables a user to change the position of an image in the photo-review, change colors of the photo-review, as well as enter and change text in the photo-review.

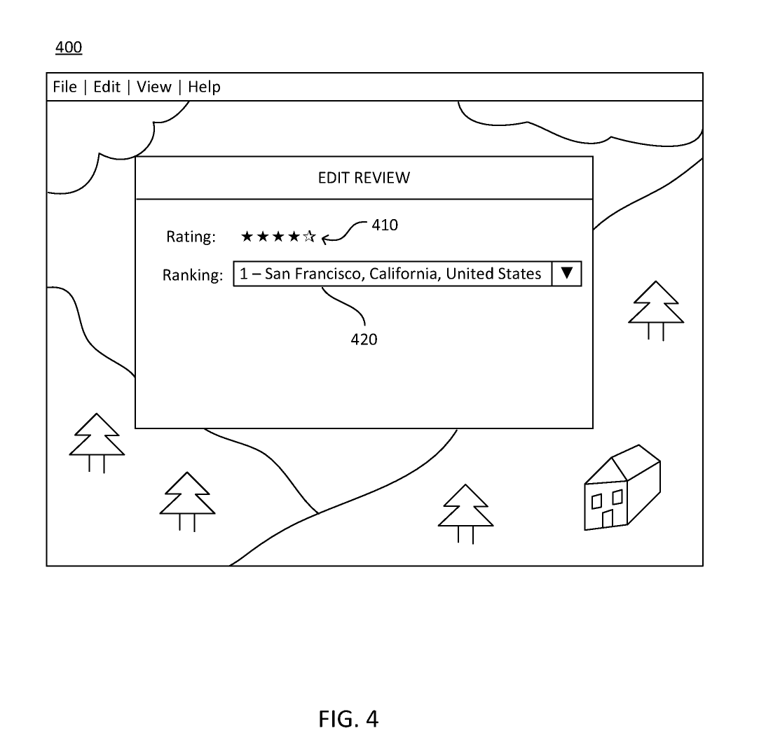

FIG. 4 illustrates an exemplary embodiment of a photo-review interface. As shown, photo-review interface 400 enables a user to enter an overall rating and a ranking for a reviewable item. As shows, a user can interact with user interface element 410 to enter a star rating for the reviewable item. In this instance, a user has selected to give the reviewable item a 4 start rating. Further, a user can interact with user interface element 420 to rank a specified reviewable item.

FIG. 5 illustrates an exemplary embodiment of a photo-review. In some embodiments photo-review 500 can comprise heading 560 that describes photo-review 500, such as “Decor to Die For,” or “Best Vacation Spot Ever!” Photo-review 500 can also comprise one or more sub-sections 555, one or more selected images 550, and/or one or more background images 580. In some embodiments photo-review 500 must contain sub-section 555, selected image 550, and/or background image 580. Subsection 555, selected image 550 and/or background image 580 can by pre-associated with the reviewable item, uploaded by a user, or obtained from a 3^{rd} party. In addition, photo-review 500 can comprise rating 520 and/or ranking 530. In some embodiments, ranking 530 can be shown in context. For example, ranking 530 can be shown in a list of rankings associated with a user that created the review.

In some embodiments, photo-review 500 can be rendered and/or stored as an image file (e.g., a bitmap (.bmp), a graphics interchange format image (.gif), etc.) or as portable document file (.pdf). In some embodiments, photo-review 500 can be displayed on a review website. As an example, all of the photo-reviews created by a user can be shown on a page associated with that user. In some embodiments, photo-review 500 can be stored as a portable image or document such that the photo-review 500 can be emailed, sent to a social network, texted, shared, etc. In some embodiments a page and/or application used to create photo-reviews can include a button or widget to email or otherwise share the review.

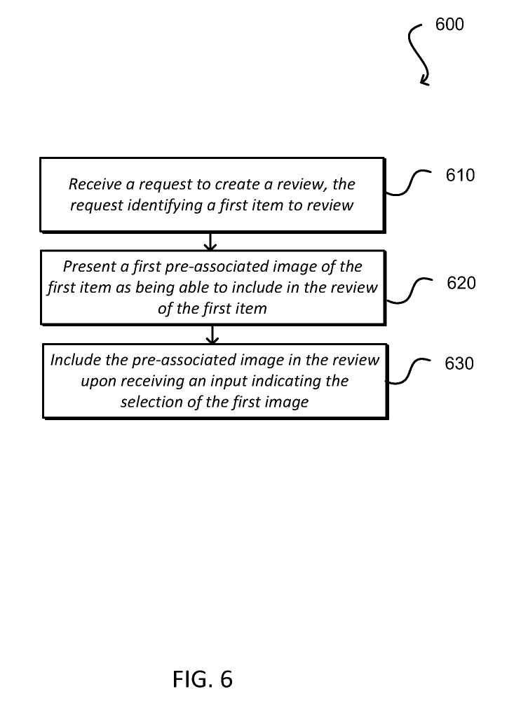

FIG. 6 illustrates an exemplary method embodiment of creating a photo-review. As shown, the method begins at block 610 where a request to create a photo-review is received. The request can identify a first reviewable item to review. For example, the request can be to create a photo-review for a hotel, restaurant, product, etc.

Upon receiving the request, the method continues to block 620 where at least on pre-associated image of the first reviewable item is presented to the user as possible image to include in the photo-review. In some embodiments, the user can be presented with all pre-associated images associated with the selected reviewable item. Alternatively, in some embodiments, a subset of the pre-associated images can be presented to the user. For example, the subset can be selected based on input received by a user, the size of the images in relation to the size of a configurable area of a photo-review template, etc.

The method then continues to block 630 where an input selecting one of the pre-associated images is received. For example, the input can be received as a result of a user selecting a pre-associated image using a input device such as a mouse, touchscreen, etc. Upon receiving the input, the method continues to block 640 where the selected pre-associated image is included in the photo-review. The method then ends.

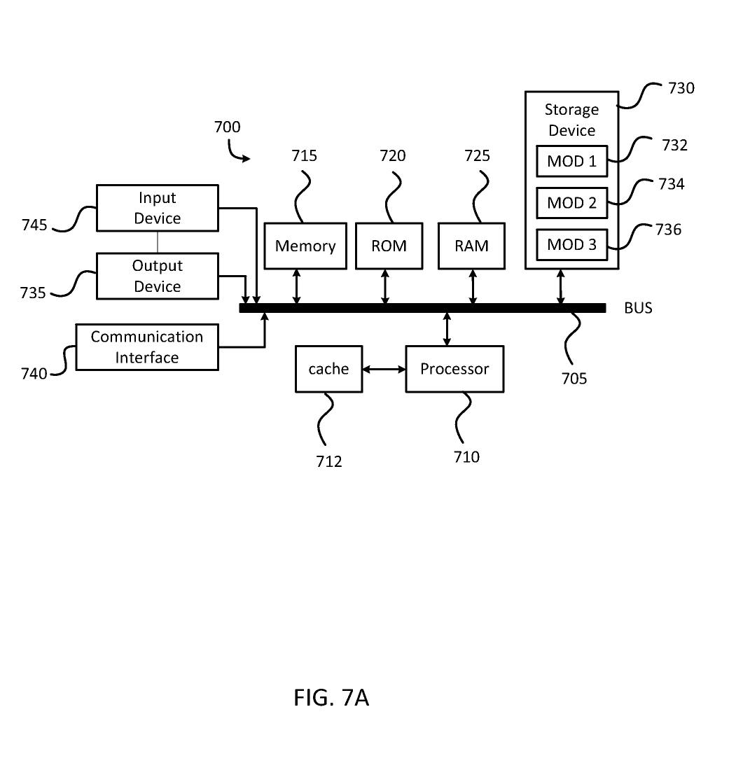

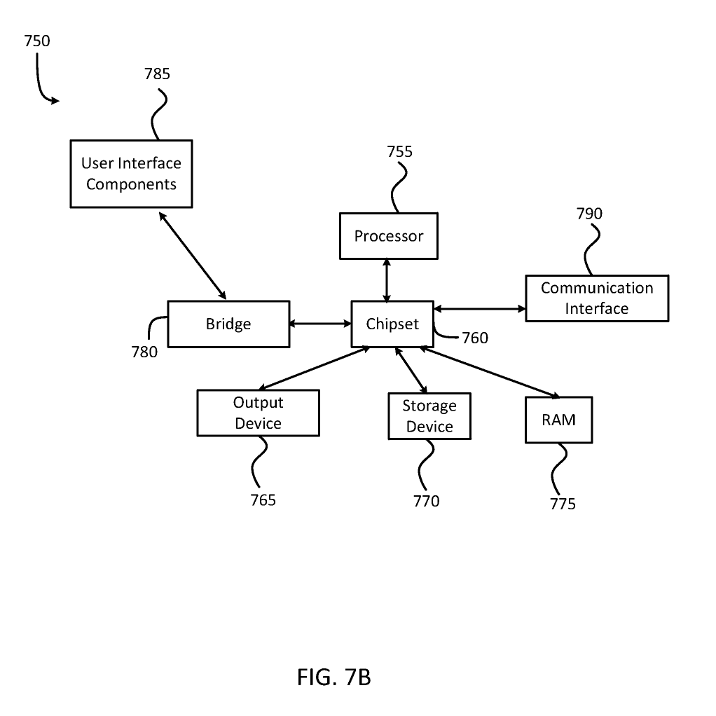

FIG. 7A, and FIG. 7B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, by a processor, a first request to create a photo-review, the request identifying a first reviewable item to be reviewed;
identifying a first group of pre-associated images based on the first reviewable item, wherein the first group of pre-associated images were pre-associated with the first the first reviewable item prior to receiving the first request;
presenting at least a first pre-associated image from the first group of pre-associated images as being available to include in the photo-review; and
upon receiving an input indicating selection of the first pre-associated image, including the first pre-associated image in the photo-review.

2. The method of claim 1, further comprising:
presenting a second pre-associated image from the first group of pre-associated images as being available to include in the photo-review; and
upon receiving a second input indicating selection of a second pre-associated image, including the second pre-associated image in the photo-review.

3. The method of claim 1, further comprising:
providing at least a first template for the photo-review, the first template including a first configurable area configured to receive an image, wherein the first pre-associated image is presented in the first configurable area.

4. The method of claim 3, further comprising:
determining a size of the first configurable area;
determining an image size of the first pre-associated image; and
upon a determination that the image size of the first pre-associated image is within a predetermined variance of the size of the first configurable area, selecting to present the first pre-associated image as being available to include in the photo-review.

5. The method of claim 3, further comprising:
determining a review focus associated with the first template, wherein the review focus indicates an element of the reviewable item that is being reviewed; and
determining an image focus of the first pre-associated image, wherein the image focus indicates an element of the reviewable items represented by the first pre-associated image; and
upon a determination that the image focus is related to the review focus, selecting to present the first pre-associated image as being available to include in the photo-review.

6. The method of claim 5, wherein the review focus is determined from a photo-review heading selected for the photo-review.

7. The method of claim 5, wherein the review focus is determined from an analysis of text entered by a user into the first template.

8. A system comprising:
a processor; and
a memory containing instructions that, when executed, cause the processor to:
receive a first request to create a photo-review, the request identifying a first reviewable item to be reviewed;
identify a first group of pre-associated images based on the first reviewable item, wherein the first group of pre-associated images were pre-associated with the first the first reviewable item prior to receiving the first request;
present at least a first pre-associated image from the first group of pre-associated images as being available to include in the photo-review; and
upon receiving an input indicating selection of the first pre-associated image, include the first pre-associated image in the photo-review.

9. The system of claim 8, wherein the instructions further cause the processor to:
present a second pre-associated image from the first group of pre-associated images as being available to include in the photo-review; and
upon receiving a second input indicating selection of a second pre-associated image, include the second pre-associated image in the photo-review.

10. The system of claim 8, wherein the instructions further cause the processor to:
provide at least a first template for the photo-review, the first template including a first configurable area configured to receive an image, wherein the first pre-associated image is presented in the first configurable area.

11. The system of claim 10, wherein the instructions further cause the processor to:
determine a size of the first configurable area;
determine an image size of the first pre-associated image; and
upon a determination that the image size of the first pre-associated image is within a predetermined variance of the size of the first configurable area, select to present the first pre-associated image as being available to include in the photo-review.

12. The system of claim 8, wherein the instructions further cause the processor to:
determine a review focus associated with the first template, wherein the review focus indicates an element of the reviewable item that is being reviewed; and
determine an image focus of the first pre-associated image, wherein the image focus indicates an element of the reviewable items represented by the first pre-associated image; and
upon a determination that the image focus is related to the review focus, select to present the first pre-associated image as being available to include in the photo-review.

13. The system of claim 12, wherein the review focus is determined from a photo-review heading selected for the photo-review.

14. The system of claim 12, wherein the review focus is determined from an analysis of text entered by a user into the first template.

15. A non-transitory computer-readable medium containing instructions that, when executed by a computing device, cause the computing device to:
receive a first request to create a photo-review, the request identifying a first reviewable item to be reviewed;
identify a first group of pre-associated images based on the first reviewable item, wherein the first group of pre-associated images were pre-associated with the first the first reviewable item prior to receiving the first request;
present at least a first pre-associated image from the first group of pre-associated images as being available to include in the photo-review; and
upon receive an input indicating selection of the first pre-associated image, including the first pre-associated image in the photo-review.

16. The non-transitory computer-readable medium of claim 15, wherein the instructions further cause the computing device to:
present a second pre-associated image from the first group of pre-associated images as being available to include in the photo-review; and
upon receiving a second input indicating selection of a second pre-associated image, include the second pre-associated image in the photo-review.

17. The non-transitory computer-readable medium of claim 15, wherein the instructions further cause the computing device to:
provide at least a first template for the photo-review, the first template including a first configurable area configured to receive an image, wherein the first pre-associated image is presented in the first configurable area.

18. The non-transitory computer-readable medium of claim 17, wherein the instructions further cause the computing device to:
determine a size of the first configurable area;
determine an image size of the first pre-associated image; and
upon a determination that the image size of the first pre-associated image is within a predetermined variance of the size of the first configurable area, select to present the first pre-associated image as being available to include in the photo-review.

19. The non-transitory computer-readable medium of claim 17, wherein the instructions further cause the computing device to:
determine a review focus associated with the first template, wherein the review focus indicates an element of the reviewable item that is being reviewed; and
determine an image focus of the first pre-associated image, wherein the image focus indicates an element of the reviewable items represented by the first pre-associated image; and
upon a determination that the image focus is related to the review focus, select to present the first pre-associated image as being available to include in the photo-review.

20. The non-transitory computer-readable medium of claim 19, wherein the review focus is determined from a photo-review heading selected for the photo-review.
